(19) United States
(12) Patent Application Publication
(10) Pub. No.: US 2026/0366099 A1
(43) Pub. Date: Nov. 19, 2026

(54) REAGENT COMPOSITIONS, APPARATUS AND METHODS FOR EXTRACTING LITHIUM FROM MIXED SALTS

(71) Applicant: Energy Exploration Technologies, Inc., Austin, TX (US)

(72) Inventors: Jack Bender, Austin, TX (US); Amit Patwardhan, Austin, TX (US); Reza Ghazfar, Austin, TX (US)

(73) Assignee: Energy Exploration Technologies, Inc., Austin, TX (US)

(21) Appl. No.: 19/487,913

(22) PCT Filed: May 23, 2024
(86) PCT No.: PCT/US2024/030845

§ 371 Date: Nov. 25, 2025

Related U.S. Application Data
(60) Provisional application No. 63/469,195, filed on May 26, 2023.

(51) Int. Cl. C22B 3/26; C22B 3/04; C22B 26/12

(52) U.S. Cl. CPC C22B 3/26; C22B 3/04; C22B 26/12

(57) ABSTRACT

Disclosed are methods of extracting lithium from an aqueous solution containing mixed salts. The methods include dissolving or heap leaching one or more mixed salts in an aqueous medium to form an aqueous mixed salt solution comprising lithium; contacting the aqueous mixed salt solution with a reagent composition; and extracting the lithium from the aqueous mixed salt solution to form a lithium depleted aqueous phase and a lithium enriched organic phase. Also disclosed are related lithium selective reagent compositions and systems.

### FIELD

The disclosure relates to reagent compositions, apparatus and methods for extracting lithium from mixed salts (e.g., waste salts, carnallite salts) containing magnesium (e.g., magnesium chloride, magnesium sulfate, etc.) in high amounts.

### BACKGROUND

In the world's transition to clean energy, electricity storage platforms play an important role. Lithium batteries are at the forefront of electricity storage technologies because inter alia they charge faster, last longer and have a higher power density to provide more battery life in a lighter package than conventional batteries. Lithium storage devices are useful for electrification of the transportation sector, electric vehicles, battery storage for electric utilities and in many other applications to reduce carbon emissions and store electricity.

Lithium is typically extracted from underground deposits of brine water and ore made of compounds containing lithium. Brines from salars and salt lakes, as well as spodumene ores, are the primary sources of lithium, while geothermal brines represent secondary sources. Carnallite and other lithium, potassium and magnesium containing salts are waste products following extraction of lithium from brines. A loss of lithium containing salts is a loss of lithium yield in these processes.

Classical methods of lithium extraction rely on brine evaporation in open ponds to maximize element concentration for further purification; however, these methods are very slow (evaporation of ponds to the desired level can take up to 24 months) and strongly dependent on region-specific weather conditions that vary throughout the year. Newer technologies based on precipitation, adsorption, solvent extraction and membranes can be used for brine concentration and may increase the economic viability of minerals extracted from sea water and other geothermal brines. However, these methods produce carnallite and other lithium, potassium and magnesium containing salts (collectively referred to as “mixed salts”) as a waste product. There is a need for compositions and methods to extract lithium from mixed salts to convert this waste product into a valuable byproduct.

### BRIEF SUMMARY

Disclosed herein according to various embodiments, are methods of extracting lithium from an aqueous solution containing mixed salts. The methods can include dissolving or heap leaching one or more mixed salts in an aqueous medium to form an aqueous mixed salt solution comprising lithium; contacting the aqueous mixed salt solution with a reagent composition; and extracting the lithium from the aqueous mixed salt solution to form a lithium depleted aqueous phase and a lithium enriched organic phase. The one or more mixed salts can include, but are not limited to, Bischofite, Carnallite, Lithium Carnallite, Kieserite, Lithium sulfate monohydrate or combinations thereof. The aqueous medium can be comprised of water, sea water, brine, brackish water, a raffinate stream, an impurity rich stream from a lithium extraction process, or combinations thereof. According to various embodiments, the aqueous mixed salt solution includes, but is not limited to, lithium chloride, lithium sulfate, lithium hydroxide, lithium nitrate or combinations thereof. In some embodiments, the aqueous mixed salt solution comprises magnesium, potassium, calcium, sodium, or combinations thereof. In at least one embodiment, the aqueous mixed salt solution comprises magnesium in an amount of at least about 20,000 ppmw. In one or more embodiments, the aqueous mixed salt solution comprises a total dissolved solids concentration of about 20% to about 50%.

According to one or more embodiments, the reagent composition comprises at least one lithium selective extractant (e.g., a zwitterionic extractant). In various embodiments, the at least one lithium selective extractant has the following formula (I) or (II):

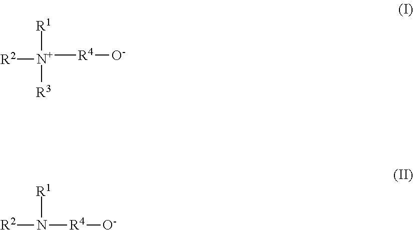

wherein R¹, R² and R³ is each independently a chemical bond, hydrogen, a methyl group, a straight or branched C₂-C₂₀ alkyl group, a straight or branched C₂-C₂₀ alkenyl group, a straight or branched C₂-C₂₀ alkynyl group, wherein each of the C₂-C₂₀ alkyl, alkenyl or alkynyl groups may be interrupted with N, O or S, and
wherein R⁴—O⁻ is a carboxylate anion, a sulfur trioxide anion, an acetamide anion, which may be interrupted by a methyl group, a straight or branched C₂-C₂₀ alkenyl group, a straight or branched C₂-C₂₀ alkynyl group, wherein each of the C₂-C₂₀ alkyl, alkenyl or alkynyl groups may be interrupted with N, O or S.

In one or more embodiments, the reagent composition comprises at least one lithium selective extractant having formula (III):

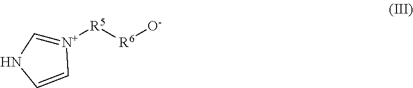

wherein R⁵ is hydrogen, a methyl group, a straight or branched C₂-C₂₀ alkenyl group, a straight or branched C₂-C₂₀ alkynyl group, wherein each of the C₂-C₂₀ alkyl, alkenyl or alkynyl groups may be interrupted with N, O or S, and
wherein R⁶—O⁻ is a carboxylate anion, a sulfur trioxide anion, an acetamide anion, which may be interrupted by a methyl group, a straight or branched C₂-C₂₀ alkenyl group, a straight or branched C₂-C₂₀ alkynyl group, wherein each of the C₂-C₂₀ alkyl, alkenyl or alkynyl groups may be interrupted with N, O or S.

Example embodiments of lithium selective extractants include, but are not limited to, those with the following formulas:

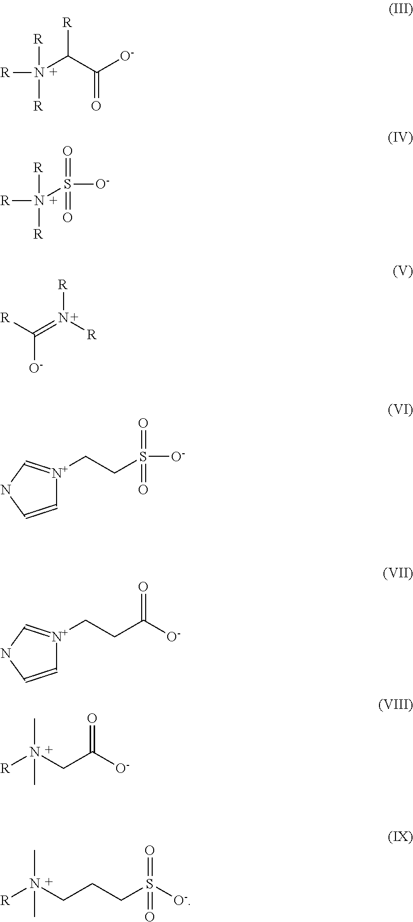

According to one or more embodiments, the reagent composition comprises at least one lithium selective extractant having formula (XI):

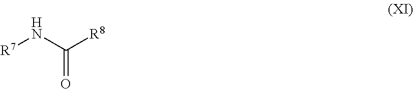

wherein R⁷ and R⁸ is each independently a methyl group, a straight or branched C₂-C₂₀ alkenyl group, a straight or branched C₂-C₂₀ alkynyl group, wherein each of the C₂-C₂₀ alkyl, alkenyl or alkynyl groups may be interrupted with N, O, S or carbonyl.

In some embodiments (e.g., when the complexes formed benefit from stabilization), the reagent compositions contain at least one modifier. The at least one modifier can include one or more functional group having a dipole moment and/or that is attached to a highly polar ionic bond. In some embodiments, the at least one modifier comprises an aliphatic component that is attracted to non-polar moieties of the at least one lithium selective extractant. In various embodiments, the at least one modifier comprises one or more functional group chosen from a diether, amide, imide, ketone, alcohol, ether, alkyl phosphine, phosphate, ester, and/or nitrile. Suitable modifiers include, but are not limited to, 1,6-di-t-butoxy hexane, N,N-Dimethyldecanamide, Di (ethylene glycol) dibutyl ether, N,N-Dimethyldecanamide, N,N-Diethyldodecanamide, N,N-Diethyl-2-ethyl hexanamide, 1,4-bis-t-Butoxy butane, 2-Ethylhexyl succinimide, 4-t-butylcyclohexanone, iminodiacetic acid (IDA), Dodecanol, 2,2,4-Trimethyl-1,3-pentanediol diisobutyrate (TXIB), Ethyoxylated isotridecyl phosphate (TDA), Cydecanol, 7-Ethyl-2-methyl-undecanol, Trimethyl nonanol, 4-Isopropyl cyclohexanone, t-Butyl octyl ether, 3-Isopropyl cyclohexanone, 3,3,5-Trimethyl cyclohexanone, Methyl n-propyl ketone (Eastman C-11 Ketone), 5-Ethyl-2-nonanone, a mixture of phosphine oxides (Cyanex 923), Tributyl phosphate, 6-Undecanone, Heptyl 2-ethylbutyrate, 2-Ethylbutyl caproate, and/or 3-(Cyclohexyl)-propionitrile.

Methods according to various embodiments herein may further comprise emulsifying the lithium enriched organic phase and/or separating the lithium salt depleted aqueous phase from the lithium enriched organic phase. Additionally, the methods may include stripping the lithium from the lithium enriched organic phase, optionally, wherein about 70% to about 99%, or about 95% of the lithium is stripped from the lithium enriched organic phase. In some embodiments, the overall extraction of lithium from the aqueous mixed salt solution is greater than about 70%, greater than about 80%, greater than about 90%, greater than about 92%, or about 70% to about 99%, or about 80% to about 93. The selectivity of lithium over magnesium is about 1 to about 50, about 5 to about 30, or about 10 to about 25.

### SUMMARY OF THE DRAWINGS

The present disclosure is illustrated by way of example, and not by way of limitation, in the figures of the accompanying drawings in which like references indicate similar elements.

FIG. 1 shows a schematic of an embodiment of a mixed salt precipitation process.

FIG. 2 shows a schematic of an embodiment of a mixed salt precipitation process.

FIG. 3 shows a schematic of an embodiment of a mixed salt precipitation process.

FIG. 4 shows a representation of a heap leaching process for preparing an aqueous solution of mixed salts according to embodiments herein.

FIG. 5 shows a representation of a loaded zwitterionic double salt.

### DEFINITIONS

Reference throughout this specification to, for example, “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “In one or more embodiments” in various places throughout this specification are not necessarily referring to the same embodiment of the invention. Furthermore, the particular features, structures, materials, or characteristics may be combined in any suitable manner in one or more embodiments.

As used herein, the singular forms “a,” “an,” and “the” include plural references unless the context clearly indicates otherwise. Thus, for example, reference to “a depurator vessel” includes a single depurator vessel as well as more than one depurator vessel.

As used herein, the term “about” in connection with a measured quantity, refers to the normal variations in that measured quantity as expected by one of ordinary skill in the art in making the measurement and exercising a level of care commensurate with the objective of measurement and the precision of the measuring equipment. In certain embodiments, the term “about” includes the recited number±10%, such that “about 10” would include from 9 to 11.

The term “at least about” in connection with a measured quantity refers to the normal variations in the measured quantity, as expected by one of ordinary skill in the art in making the measurement and exercising a level of care commensurate with the objective of measurement and precisions of the measuring equipment and any quantities higher than that. In certain embodiments, the term “at least about” includes the recited number minus 10% and any quantity that is higher such that “at least about 10” would include 9 and anything greater than 9. This term can also be expressed as “about 10 or more.” Similarly, the term “less than about” typically includes the recited number plus 10% and any quantity that is lower such that “less than about 10” would include 11 and anything less than 11. This term can also be expressed as “about 10 or less.”

Unless otherwise indicated, all parts and percentages are by weight. Weight percent (wt. %), if not otherwise indicated, is based on an entire composition free of any volatiles, that is, based on dry solids content.

Reference throughout this specification to a chemical element or a “metal” encompasses the basic chemical element or metal itself, ions, molecules containing the chemical element or metal, and/or ionic compounds containing the chemical element or metal, or combinations thereof. For example, “lithium” refers to the element lithium, lithium ions, lithium-containing molecules and lithium-containing ionic compounds, or combinations thereof.

### DETAILED DESCRIPTION

Embodiments of the disclosure are described more fully hereinafter with reference to the accompanying drawings, which form a part hereof, and which show, by way of illustration, example features. The features can, however, be embodied in many different forms and should not be construed as limited to the combinations set forth herein; rather, these combinations are provided so that this disclosure will be thorough and complete and will fully convey the scope. The following detailed description is, therefore, not to be taken in a limiting sense.

Described herein are reagent compositions, apparatus and methods for extracting lithium compounds from mixed salts. Carnallite salts, together with other lithium, potassium and magnesium containing salts, can form in processes that extract lithium compounds from aqueous solutions containing high amounts of magnesium. For example, the following salts may form:

Bischofite—MgCl₂·H₂O

Carnallite—KMgCl₃·H₂O

Lithium Carnallite—LiMgCl₃·7H₂O

Kieserite—MgSO₄·H₂O

Lithium sulfate monohydrate—Li₂SO₄·H₂O

Mixed salts may be formed in large quantities, for example, by certain lithium producers where they are generally considered waste products. While there have been attempts to recover lithium from mixed salts, the magnesium content (as well as other salts such as Ca, K, and Na) makes it economically challenging.

Preparing an aqueous stream containing mixed salts according to embodiments herein can be accomplished in a number of ways. For example, dissolving mixed salt precipitates from a pond system in an aqueous solution (e.g., water) and/or heap leaching mixed salts with an aqueous solution.

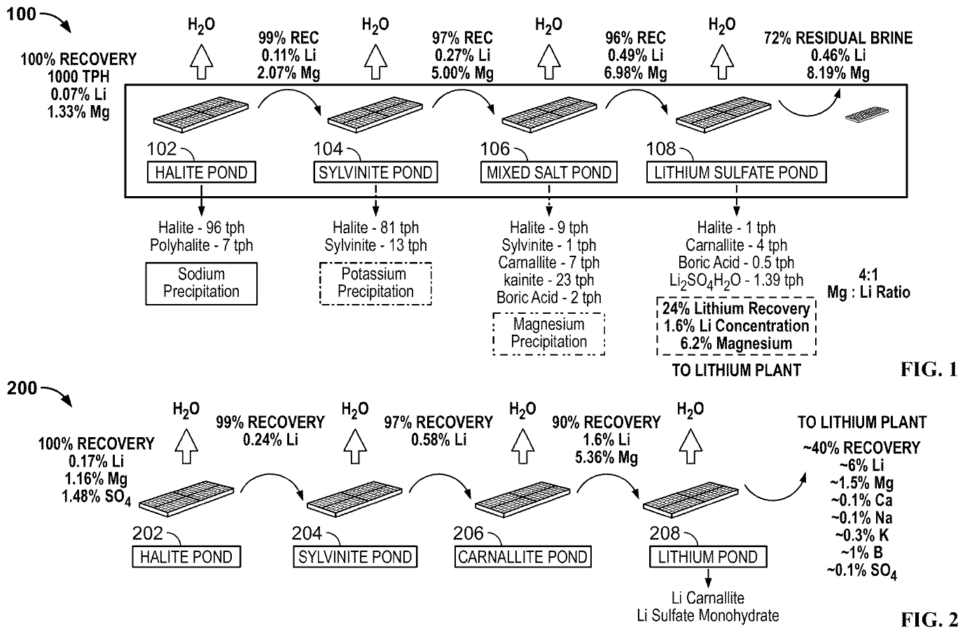

FIG. 1 shows an embodiment of a lithium extraction scheme 100 in a pond system that results in the formation of mixed salts. As shown in FIG. 1, a lithium containing solution flows into a series of cascading ponds. The first pond 102 precipitates sodium salts including halite and polyhalite salts from the lithium containing solution. The effluent from the halite pond 102 flows into a second pond 104 where potassium salts are precipitated from the received sodium salt purified solution forming halite and sylvinite as byproducts. In a third pond 106, magnesium salts are precipitated from the potassium purified solution forming halite, sylvinite, carnallite, kieserite and boric acid byproducts. The magnesium purified solution is then introduced into a fourth pond 108 to precipitate lithium containing salts. In lithium sulfate pond 108, halite, carnallite, boric acid and Li₂SO₂·H₂O byproducts are removed.

Another embodiment of a lithium extraction scheme is shown in FIG. 2. A lithium containing solution flows into a series of cascading ponds. A halite pond 202 precipitates halite salts from the lithium containing solution. The effluent from the halite pond 202 flows into a sylvinite pond 204 where sylvinite salts are precipitated from the received halite salt purified solution. In a carnallite pond 206, carnallite salts are precipitated from the sylvinite purified solution. The carnallite purified solution is then introduced into a lithium pond 208 where lithium containing salts (e.g., lithium carnallite and lithium sulfate monohydrate) are precipitated from the carnallite purified solution.

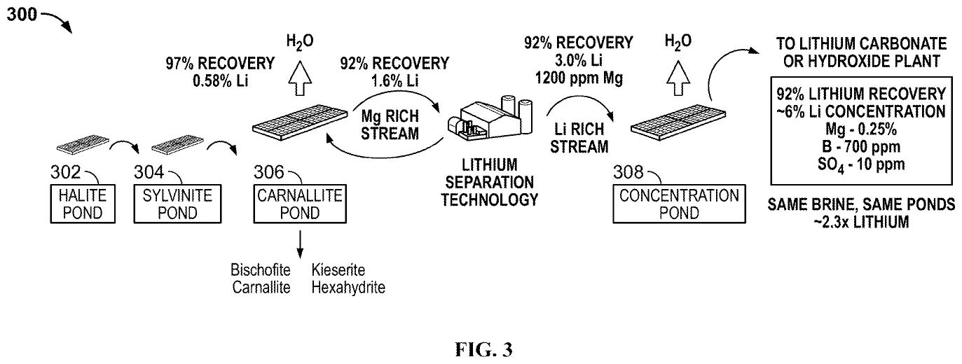

A further embodiment of a lithium extraction scheme is shown in FIG. 3. A lithium containing solution is received by a halite pond 302 to precipitate halite salts from the lithium containing solution. The effluent from the halite pond 302 flows into a sylvinite pond 304 where sylvinite salts are precipitated from the received halite salt purified solution. In a carnallite pond 306, carnallite salts are precipitated from the sylvinite purified solution where bischofite, carnallite, kieserite and hexahydrite among others are removed. The carnallite purified solution is then introduced into a lithium pond 308 where lithium containing salts (e.g., lithium carnallite and lithium sulfate monohydrate) are precipitated from the carnallite purified solution.

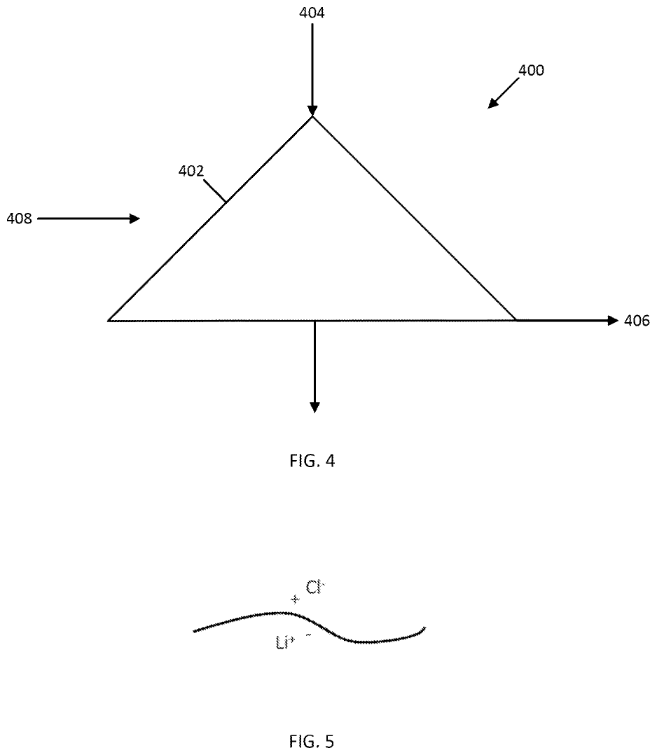

An embodiment of a heap leaching scheme 400 for forming an aqueous solution containing dissolved mixed salts is shown in FIG. 4. A collection of mixed salts comprising, for example, carnallite, bischofite, lithium carnallite and kieserite are provided in a heap 402. An aqueous solution (e.g., water) 404 is applied to the top of heap 402 at 20 °C and flows down through the mixed salts dissolving salt compounds as it flows. The mixed salt rich aqueous solution 406 exiting heap 402 is rich in the mixed salts as shown in FIG. 4. The mixed salt rich aqueous solution may then be fed to a separation system (e.g., a solvent extraction system) where lithium is extracted from the aqueous solution according to various embodiments herein. Fresh mixed salt precipitates can be fed to heap 402 via inlet stream 408. As shown in FIG. 4, the mixed salt precipitates can have the described composition. Following heap leaching, the mixed salt depleted heap or barren heap residue can comprise the compounds as shown.

Mixed salts form as the concentration of MgCl₂ increases to saturation in the presence of KCl and LiCl. Once saturation is reached, the mixed salts precipitate out of solution. As the process progresses, the lithium is concentrated and is ultimately separated from the precipitated magnesium salts. This process removes the majority of magnesium from lithium rich brines and provides a substantially pure lithium salt solution for industrial or battery use. However, lithium remains in the mixed salt precipitates. It would be beneficial to extract the lithium contained in the lithium mixed salts to increase overall yield of the lithium.

To ensure high lithium yield, magnesium removal should be maximized while lithium is retained in the solution. Some mixed salts such as carnallite and lithium carnallite, however, have similar solubilities in aqueous solutions. According to various embodiments, described herein are reagent compositions and methods for selectively extracting lithium from aqueous solutions containing dissolved mixed salts. In one or more embodiments, the methods include dissolving one or more mixed salts in an aqueous solution, for example, in water or a brine solution that contains a low ionic content (e.g., process water or sea water). The amount of aqueous solution provided should be about the minimum amount required to dissolve the mixed salts. Using the minimal amount can reduce water usage and waste. For example, the resulting aqueous solution is introduced into a solvent extraction system that is sized based on the flow rate of the aqueous. The lower the volume of the aqueous, the lower the capital expenditure (CAPEX) and operating expenditure (OPEX) for the solvent extraction plant.

Upon solubilizing (or heap leaching) a mixture of mixed salts, for example, bischofite carnallite and/or lithium carnallite, etc., with a high total dissolved solids (TDS) concentration as a result of minimal solvent use, the magnesium concentration of the solution would be quite high, for example, about 20,000 ppmw to about 110,000 ppmw, or any individual value or sub-range within this range. Any salts of Mg, K, Ca, Na, Li and/o LiCl may be present in the aqueous solution containing the dissolved mixed salts. In one or more embodiments, the method includes dissolving mixed salts in an aqueous solution to provide a Mg concentration of at least about 20,000 ppmw, at least about 30,000 ppmw, at least about 40,000 ppmw, at least about 50,000 ppmw, about 20,000 ppmw to about 100,000 ppmw, or any individual value or sub-range within these ranges. The concentration of TDS in the mixed brine solution can be about 20% to about 50%, or any individual value or sub-range within this range. The solvent extraction process operates more effectively as the magnesium concentration is increased. Once a mixed salt brine containing a high concentration of Mg is formed, it is introduced into a solvent extraction system.

Conventional solvent extraction systems have difficulty extracting lithium in the presence of magnesium due to preferential loading of magnesium resulting from stability of the Mg/extractant complex as compared to that for the Li/extractant complex. Equations 1 and 2 illustrate how traditional extractants function.

RH+[Li⁺]⇄R⁻Li⁺+H⁺ Eq. (1)

2RH+[M²⁺]⇄(R⁻)₂Mg²⁺+2H⁺ Eq. (2)

An extractant is deprotonated to form an anion which forms a complex with a cation (e.g. Li⁺ or Mg²⁺). For aqueous solutions containing high concentrations of magnesium (e.g., greater than about 20,000 ppmw), traditional extractants will not provide selectivity for lithium over magnesium.

According to various embodiments, contacting the mixed salt aqueous solution with a lithium selective reagent composition can preferentially extract lithium from the solution over magnesium. Such reagent compositions can include at least one lithium selective extractant (e.g., a zwitterionic extractant) capable of selectively extracting lithium compounds. In one or more embodiments, the extractant is a zwitterionic extractant including a double ion complex that selectively extracts lithium.

According to one or more embodiments, the lithium selective extractant is a zwitterionic extractant having both an anionic charge and a cationic charge. As shown in FIG. 5, such extractants having an anion and cation can form a double ionic salt. For salts with a valency of 1 for the cation and the anion, the structure of the complex is simple as shown in FIG. 5. For example, as shown in Equation 3, such extractants can suitably form complexes with LiCl salts.

R⁽⁻⁾⁽⁺⁾+Li⁺Cl⁻⇄Cl⁽⁻⁾⁽⁺⁾R⁽⁻⁾Li⁽⁺⁾ Eq. (3)

For salts having a higher valency, such as MgCl₂, the magnesium would have to bridge two zwitterionic extractants. This is a considerably more difficult complex to form and, without being bound by any particular theory, it is believed that steric hindrance is an obstacle to forming such complexes.

In the case of other salts having a single valency found in aqueous lithium solutions (e.g., brines), such as NaCl and KCl, these cations have a relatively large ionic radius. For example, the ionic radius of Li is 76 picometers whereas for Na it is 102 picometers and K it is 151 picometers. Zwitterionic compounds often form complexes having ring structures. The most stable complexes are five (5) to six (6) member rings where the radius of the cations are minimized. As such, sodium and potassium transfer with lithium selective extractants is very low.

Reagent compositions useful for selectively extracting lithium over magnesium from an aqueous solution containing dissolved mixed salts can include at least one lithium selective extractant (e.g., a zwitterionic extractant). In one or more embodiments, the at least one lithium selective extractant comprises one or more compounds having the following formula (I) or (II):

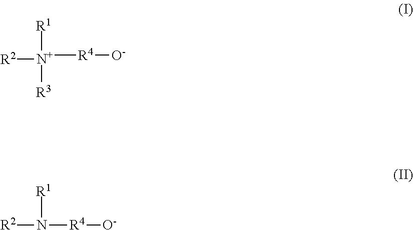

wherein R¹, R² and R³ is each independently a chemical bond, hydrogen, a methyl group, a straight or branched C₂-C₂₀ alkyl group, a straight or branched C₂-C₂₀ alkenyl group, a straight or branched C₂-C₂₀ alkynyl group, wherein each of the C₂-C₂₀ alkyl, alkenyl or alkynyl groups may be interrupted with N, O or S, and
wherein R⁴—O is a carboxylate anion, a sulfur trioxide anion, an acetamide anion, which may be interrupted by a methyl group, a straight or branched C₂-C₂₀ alkenyl group, a straight or branched C₂-C₂₀ alkynyl group, wherein each of the C₂-C₂₀ alkyl, alkenyl or alkynyl groups may be interrupted with N, O or S.

In one or more embodiments, the at least one lithium selective extractant includes one or more compounds having the following formula (III):

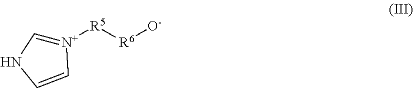

wherein R⁵ is hydrogen, a methyl group, a straight or branched C₂-C₂₀ alkenyl group, a straight or branched C₂-C₂₀ alkynyl group, wherein each of the C₂-C₂₀ alkyl, alkenyl or alkynyl groups may be interrupted with N, O or S, and
wherein R⁶—O is a carboxylate anion, a sulfur trioxide anion, an acetamide anion, which may be interrupted by a methyl group, a straight or branched C₂-C₂₀ alkenyl group, a straight or branched C₂-C₂₀ alkynyl group, wherein each of the C₂-C₂₀ alkyl, alkenyl or alkynyl groups may be interrupted with N, O or S.

Examples of lithium selective extractants suitable for use in reagent compositions according to embodiments herein include, but are not limited to, the following compounds:

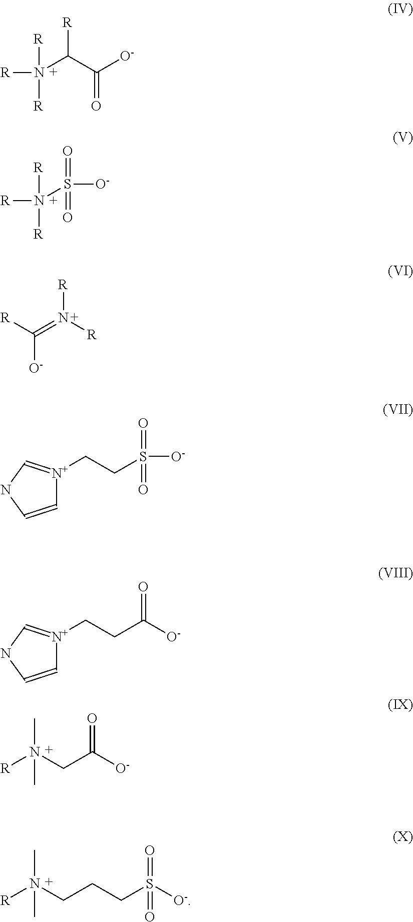

In one or more embodiments, the at least one lithium selective extractant includes one or more compounds having the following formula (XI):

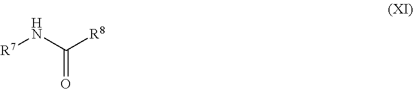

wherein R⁷ and R⁸ is each independently a methyl group, a straight or branched C₂-C₂₀ alkenyl group, a straight or branched C₂-C₂₀ alkynyl group, wherein each of the C₂-C₂₀ alkyl, alkenyl or alkynyl groups may be interrupted with N, O, S or carbonyl.

In one or more embodiments, R⁷ and R⁸ in Formula (XI) are each independently a C₃-C₆ branched alkyl, or any individual compound within this definition. In some embodiments, R⁷ and R⁸ is each independently, a methyl or branched C₃-C₉ alkyl, or any individual compound within this definition, with the proviso that only one of R⁷ or R⁸ is methyl. In at least one embodiment, R⁷ is a branched C₃-C₉ alkyl, and R⁸ is a straight C₂-C₉ alkyl, or any individual compound within this definition. In one or more embodiments, R⁷ is a straight C₂-C₉ alkyl and R⁸ is a branched C₃-C₉ alkyl.

Reagent compositions according to one or more embodiments herein further include at least one modifier. Suitable modifiers are able to stabilize the lithium containing complexes form when the mixed salt aqueous solution contacts the extractant. Stabilization is beneficial, for example, when the polarity of the organic phase is typically not high enough to stabilize the highly ionic character of the complex. Modifiers according to one or more embodiments herein can have functional groups with a dipole moment and/or may be attracted to the highly polar ionic bonds. Suitable modifiers according to embodiments may also have an aliphatic component that is attracted to the non-polar moieties of the extractants (e.g., zwitterionic extractants). This attraction essentially “shields” the ionic moieties and helps to solubilize the complexes.

According to one or more embodiments, transfer of the lithium salt (e.g., LiCl) from the aqueous solution to a different medium occurs by making an emulsion (i.e., an organic phase) to increase the surface area. The lithium selective extractant binds with the lithium salts at the interface between the brine and emulsion forming complexes. Once extraction of the one or more lithium compounds with the reagent composition is complete (e.g., after about 1 h to about 5 hours) of contact between the brine and the reagent composition), the emulsion rich in lithium complexes is allowed to coalesce. The emulsion can be produced by agitating, stirring and/or centrifuging the combination of the aqueous lithium solution with the organic reagent composition. Once coalesced, the organic phase can be easily separated from the brine phase now depleted of lithium salts. The organic phase can be washed and/or scrubbed to remove entrained water and/or loaded impurities. The washed organic phase may then be stripped with water. This stripping process is possible because the solvent-solvent extraction process does not experience an activation/deactivation mechanism using acid and/or base.

Modifiers according to various embodiments of reagent compositions described herein can contain a variety of functional groups that are polar. A non-exhaustive list of suitable modifiers for embodiments of reagent compositions herein is provided in Table 1.

TABLE 1
Modifiers Suitable for Use with Lithium Selective Extractants

| | Functional | |
|---|---|---|
| Modifier | group | MW |
| 1,6-di-t-butoxy hexane | Diether | 230.39 |
| N,N-Dimethyldecanamide | Amide | 199.34 |
| Di(ethylene glycol) dibutyl ether | Diether | 218.34 |
| N,N-Dimethyldecanamide | Amide | 199.34 |
| N,N-Diethyldodecanamide | Amide | 255.44 |
| N,N-Diethyl-2-ethyl hexanamide | Amide | 199.34 |
| 1,4-bis-t-Butoxy butane | Diether | 202.34 |
| 2-Ethylhexyl succinimide | Imide | 211.30 |
| 4-t-butylcyclohexanone | Ketone | 154.25 |
| IDA | Alcohol | 158.28 |
| Dodecanol | Alcohol | 186.34 |
| TXIB | Diester | 300.44 |
| TDA | Alcohol | 200.38 |
| Cydecanol | Alcohol | 148.00 |
| 7-Ethyl-2-methyl-undecanol | Alcohol | 214.39 |
| Trimethyl nonanol | Alcohol | 186.34 |
| 4-Isopropyl cyclohexanone | Ketone | 140.23 |
| t-Butyl octyl ether | Ether | 186.34 |
| 3-Isopropyl cyclohexanone | Ketone | 140.23 |
| 3,3,5-Trimethyl cyclohexanone | Ketone | 140.23 |
| Eastman C-11 Ketone | Ketone | 170.30 |
| 5-Ethyl-2-nonanone | Ketone | 170.30 |
| Cyanex 923 | Alkyl Phosphine | 348 |
| Tributyl phosphate | Phosphate | 266.32 |
| 6-Undecanone | Ketone | 170.30 |
| Heptyl 2-ethylbutyrate | Ester | 214.35 |
| 2-Ethylbutyl caproate | Ester | 228.38 |
| 3-(Cyclohexyl)-propionitrile | Nitrile | 137.22 |

In one or more embodiments, the at least one lithium selective extractants may be present in the reagent composition in an amount of about 5 wt % to about 100 wt %, about 15 wt % to about 95 wt %, about 20 wt % to about 80 wt %, about 50 wt % to about 70 wt %, or any individual value or sub-range within these ranges, based on the total weight of the reagent composition. In one or more embodiments, the at least one modifier may be present in the reagent composition in an amount of about 0 wt % to about 95 wt %, about 1 wt % to about 90 wt %, about 5 wt % to about 80 wt %, about 20 wt % to about 50 wt %, or any individual value or sub-range within these ranges, based on the total weight of the reagent composition. According to various embodiments, the reagent composition contains a weight ratio of the at least one lithium selective extractant to the at least one modifier of about 1:1 to about 100:1, about 2:1 to about 50:1, about 10:1 to about 20:1, or any individual value or sub-range within these ranges. In one or more embodiments, the reagent composition contains about 70 wt % extractant and about 30 wt % modifier. Each mixed salt aqueous solution containing lithium salts may be suitably extracted with different amounts of the zwitterionic extractant and modifier.

Selectivity is the measure of the transfer of a desired salt from the aqueous phase (e.g., mixed salt brine) to the organic phase (e.g., reagent composition) as compared to the transfer of other salts. Zwitterionic extractants have a wide range of selectivity. Suitable zwitterionic extractants useful in reagent compositions according to various embodiments preferentially extract lithium chloride. Equation 1 can be used to determine the selectivity of the lithium chloride extraction as compared to the extraction of other salts.

(transfer_{Li}/feed_{Li})/(transferᵢₒₙ/Feedᵢₒₙ)=selectivity for lithium (1)

Further disclosed herein according to various embodiments are treated salar brine compositions. Salar brines may be treated according to one or more embodiments described herein. Treated salar brine compositions comprise minerals including, but not limited to, lithium, magnesium, calcium, potassium, sodium, or combinations thereof. The minerals may be in solution in an aqueous medium according to various embodiments herein (e.g., water). According to one or more embodiments, minerals comprise salar waste mineral, a salar carnallite, lithium carnallite, bischofite, carnallite, kieserite or combinations thereof.

In one or more embodiments, the treated salar brine composition includes lithium at a concentration of less than about 25,000 mg/kg, less than about 20,000 mg/kg, less than about 10,000 mg/kg, less than about 5,000 mg/kg, less than about 4,000 mg/kg, less than about 3,500 mg/kg, less than about 1,500 mg/kg, less than about 400 mg/kg, or any individual value or sub-range within these ranges. In one or more embodiments, the treated salar brine composition includes magnesium at a concentration of less than about 130,000 mg/kg, less than about 60,000 mg/kg, less than about 55,000 mg/kg, than about 50,000 mg/kg, or any individual value or sub-range within these ranges. According to various embodiments, the treated salar brine composition includes a concentration of calcium of less than about 50,000 mg/kg, calcium is less than about 9,000 mg/kg, or any individual value or sub-range within these ranges.

According to various embodiments, the treated salar brine composition comprises lithium in an amount of less than about 4,000 mg/kg, magnesium in an amount of less than about 55,000 mg/kg, and calcium in an amount of less than about 12,000 mg/kg, less than about 9,000 mg/kg, less than about 8,000 mg/kg. In some embodiments, the treated salar brine contains lithium in an amount of less than about 400 mg/kg, magnesium in an amount of less than about 60,000 mg/kg, and calcium in an amount of less than about 8,000 mg/kg. In some embodiments, the treated salar brine composition comprises lithium in an amount of less than about 3,500 mg/kg, magnesium in an amount of less than about 50,000 mg/kg, and calcium in an amount of less than about 12,000 mg/kg.

Also disclosed herein are methods of using treated salar brines in various applications. Described are embodiments a method of using a treated salar brine composition, comprising extracting one or more minerals from the treated salar brine composition. Also disclosed are methods of using a treated salar brine compositions comprising injecting the treated salar brine composition into a tailings pond. Methods of using a treated salar brine composition, comprising injecting the treated salar brine composition into a salar brine reservoir or a salt flat reservoir are also disclosed.

According to further embodiments, disclosed herein are compositions comprising a lithium containing treated salar brine; and an organic composition capable of reducing the concentration of lithium in the lithium containing treated salar brine. The organic composition can comprise a reagent composition according to various embodiments described herein. The lithium containing treated salar brine can include a lithium concentration of less than about 20,000 mg/kg, less than about 5,000 mg/kg, or any individual value or sub-range within these ranges.

### EXAMPLES

### Example 1

Mixed salts containing carnallite salts were dissolved in water and the resulting mixed salt brine was combined with a reagent composition in a vessel stirred at 1750 rpm using an overhead stirrer for over 2 minutes at room temperature. The reagent composition included 70 wt % zwitterionic extractant and 30 wt % modifier. After mixing, an emulsion was allowed to coalesce at room temperature. The results of the extraction are shown in Table 2.

TABLE 2
Single contact extraction with zwitterionic extractant.

| Sample | S | B | Mg | Ca | Na | Li | K | % |
|---|---|---|---|---|---|---|---|---|
| ID | (ppm) | (ppm) | (ppm) | (ppm) | (ppm) | (ppm) | (ppm) | Recovery |
| Feed | 2485 | 5347 | 113875 | 71 | 2797 | 15030 | 1911 | |
| Raffinate | | | | | | 7555 | | 49.7 |
| Strip | 10 | 498 | 3142 | 39 | 35 | 7688 | 0 | |

The raffinate was the lithium depleted solution following solvent extraction. As shown, the selectivity of lithium over B, Mg, Na and K was very high. Calcium was not extracted effectively at a high concentration. In this case, the calcium content in the feed was at a very low concentration and, thus, the results are not a good indicator of Li/Ca selectivity. The sulfur in this case was in the form of sulfate. This anion was too large and had too high a valency to successfully extract. While the extraction efficiency was 49.7%, the strip efficiency was ~100%.

### Example 2

A mixed salt brine solution was prepared as in Example 1. A different reagent composition was used here than in Example 1. The reagent composition contained a different zwitterionic extractant than that used in claim 1 and the zwitterionic extractant was present at a concentration of 50 wt % with the modifier present at a concentration of 50 wt %. The results are shown in Table 3.

TABLE 3
Results of single contact Li extraction with
zwitterionic reagent in Example 3.

| Sample | S | B | Mg | Ca | Na | Li | K |
|---|---|---|---|---|---|---|---|
| ID | (ppm) | (ppm) | (ppm) | (ppm) | (ppm) | (ppm) | (ppm) |
| Strip | 5087 | 3587 | 88727 | 122 | 7160 | 14227 | 10504 |
| Raffinate | | | | | | 9983 | |
| Organic | | | | | | 4244 | |
| Strip | 4 | 218 | 737 | 24 | 72 | 4744 | 0 |

As shown, the reagent composition and solvent extraction process provided a high selectivity for lithium. While the extraction efficiency was 30%, the stripping efficiency was near 100%.

### Example 3

A synthetic brine with ~110,000 ppm Mg, ~71 ppm ca, ~7000 ppm Na, ~8000 ppm K and 2000 ppm Li was contacted 4 times, each with fresh organic solution. This formulation was different than in Example 1 and used no modifier. The organic and aqueous was mixed and allowed to separate. The results of the lithium extraction can be found in Table 4. With four successive contacts, the lithium was 95.6% extracted.

TABLE 4
Results of lithium extraction with
zwitterionic reagent in Example 3.

| Sample | Li (ppm) | Recovery (%) |
|---|---|---|
| Feed | 2000 | |
| 1^{st} contact | 650 | 67.5 |
| 2^{nd} contact | 338 | 83.1 |
| 3^{rd} contact | 225 | 88.8 |
| 4^{th} contact | 88 | 95.6 |

### Example 4

As mentioned in Examples 1 and 2, the lithium rich emulsions were stripped. As shown in Table 5, stripping efficiencies were very high and only dropped once the concentration of the lithium in the strip solution exceeded 15,000 ppm.

TABLE 5
Results of stripping reactions.

| | Li | Stripping |
|---|---|---|
| Sample ID | (ppm) | efficiency (%) |
| Initial Strip Feed | 9366 | |
| Organic | 7050 | |
| Strip Final (50 °C) | 16720 | 104 |
| Initial Strip Feed | 18965 | |
| Organic | 7275 | |
| Strip Final (50 °C) | 24787 | 80.00 |
| Initial Strip Feed | 18965 | |
| Organic | 7590 | |
| Strip Final (50 °C) | 24654 | 74.9 |
| Initial Strip Feed | 14680 | |
| Organic | 6780 | |
| Strip Final (50 °C) | 20045 | 79.6 |

Temperature was observed to have a beneficial impact on stripping; however, the increase in lithium concentration was not substantial. The stripping results show that lithium concentrations can be increased by either decreasing the strip solution quantity or by reusing the stripping solution until desired strip concentrations are met. Lower strip efficiencies do not result in loss of lithium, they just require a larger quantity of extractant to reach desired results.

The above examples demonstrate that the solvation of the mixed salts makes a suitable brine for the extraction of lithium by a zwitterionic extractant and or reagent compositions according to embodiments herein. The reagent composition can extract about 70% to about 99%, about 80% to about 95%, or any individual value or sub-range within these ranges, of the lithium from the mixed salt brine, and enables quantitative stripping. The lithium extraction from mixed salt aqueous solutions produces a lithium enriched solution having very few impurities.

### Example 5

A brine sample, originating from Great Salt Lake and evaporated to high concentrations of Li (1824 mg/L) and Mg (116,642 mg/L), was provided. The brine sample was fed to a solvent extraction system selective for lithium when in solution with magnesium at such high concentrations. The results are shown in Table 6.

TABLE 6
Lithium recovery following solvent extraction.

| | | | | Projected Final |
|---|---|---|---|---|
| | As | | | Concentrate |
| | Received | Li | | post second |
| Analyte | Feed | Concentrate | Recovery | stage processing |
| (mg/L) | (mg/L) | (mg/L) | (%) | (mg/L) |
| Li | 1824 | 503 | 91 | 20,000-60,000 |
| Na | 1555 | 163 | 11-34 | 100-200 |
| K | 581 | 0 | 0 | 0 |
| Mg | 116642 | 808 | 2-3 | <50 |
| Ca | 26 | 6 | 80 | 0 |
| B | 1298 | 12 | 0-3 | 0 |
| S | 7696 | 13 | 0-1 | <20 |

The solvent extraction system recovered 91% of the lithium from the brine achieving very high levels of non-lithium cations and anions including sulfates and borates. Calcium was coextracted at 80%; however, the calcium concentration in the feed brine was very low and the concentration in the product was even lower. Without being bound by any particular theory, it is believed that the calcium coextraction observed may be a result of measuring low levels of ions in a high Total Dissolved Salts (TDS) background. Some sodium co-extraction also was observed. Significant improvements over conventional lithium extraction techniques were possible including achieving a lithium concentrate having a higher than expected concentration with a low extraction of magnesium (808 mg/L, 2-3%). There was very little magnesium removal and whatever was extracted was further removed and returned in the second stage of extraction. Hence, the brine, after lithium extraction, was fully available for beneficial uses of its high magnesium content at the same high concentration.

The lithium concentrate produced was amenable to a second stage solvent extraction process where the concentrate produced from the first stage was simultaneously cleaned and concentrated without evaporation. The Stage 1 and Stage 2 solvent extraction processes utilized different extractants and worked on different principles. The projected concentration of lithium in the final concentrate post Second Stage processing was 20,000-60,000 mg/L. A battery grade lithium carbonate and lithium hydroxide were produced directly from the Stage 2 product without the need for purification.

The solvent extraction-based process for this brine did not rely on adsorption as is more typically used for lithium extraction. Even though adsorption is effective, though less preferred for high lithium concentration brines, it is a difficult unit operation to operate, expensive, is only scalable by adding a large number of columns and uses a lot of fresh water. The solvent extraction process on the other hand uses very little fresh water. Solvent Extraction itself is a massively scalable process and proven in the extraction of a variety of metals extraction processes.

The foregoing description discloses example embodiments of the disclosure. Modifications of the above-disclosed assemblies, apparatus, and methods which fall within the scope of the disclosure will be readily apparent to those of ordinary skill in the art. Accordingly, while the present disclosure has been disclosed in connection with example embodiments, it should be understood that other embodiments may fall within the scope of the disclosure, as defined by the following claims.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method of extracting lithium from an aqueous solution containing mixed salts, the method comprising:
dissolving or heap leaching one or more mixed salts in an aqueous medium to form an aqueous mixed salt solution comprising lithium;
contacting the aqueous mixed salt solution with a reagent composition; and
extracting the lithium from the aqueous mixed salt solution to form a lithium depleted aqueous phase and a lithium enriched organic phase.

2. The method of claim 1, wherein the one or more mixed salts comprise Bischofite, Carnallite, Lithium Carnallite, Kieserite, Lithium sulfate monohydrate or combinations thereof.

3. The method of claim 1, wherein the aqueous medium comprises water, sea water, brine, brackish water, a raffinate stream, an impurity rich stream from a lithium extraction process, or combinations thereof.

4. The method of claim 1, wherein at least one of:
the aqueous mixed salt solution comprises lithium chloride, lithium sulfate, lithium hydroxide, lithium nitrate or combinations thereof,
the aqueous mixed salt solution comprises magnesium, potassium, calcium, sodium or combinations thereof,
the aqueous mixed salt solution comprises magnesium in an amount of at least about 20,000 ppmw, or
the aqueous mixed salt solution comprises a total dissolved solids concentration of about 20% to about 50%.

5. (canceled)

6. (canceled)

7. (canceled)

8. (canceled)

9. The method of claim 1, wherein the reagent composition comprises a lithium selective extractant, or
wherein the reagent composition comprises at least one lithium selective extractant having formula (I) or (II): 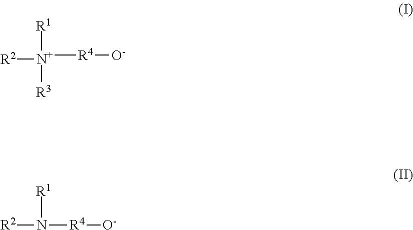
wherein R¹, R² and R³ is each independently a chemical bond, hydrogen, a methyl group, a straight or branched C₂-C₂₀ alkyl group, a straight or branched C₂-C₂₀ alkenyl group, a straight or branched C₂-C₂₀ alkynyl group, wherein each of the C₂-C₂₀ alkyl, alkenyl or alkynyl groups may be interrupted with N, O or S, and
wherein R⁴—O⁻ is a carboxylate anion, a sulfur trioxide anion, an acetamide anion, which may be interrupted by a methyl group, a straight or branched C₂-C₂₀ alkenyl group, a straight or branched C₂-C₂₀ alkynyl group, wherein each of the C₂-C₂₀ alkyl, alkenyl or alkynyl groups may be interrupted with N, O or S.

10. The method of claim 1, wherein the reagent composition comprises at least one lithium selective extractant having formula (III): 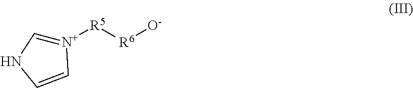
wherein R⁵ is hydrogen, a methyl group, a straight or branched C₂-C₂₀ alkenyl group, a straight or branched C₂-C₂₀ alkynyl group, wherein each of the C₂-C₂₀ alkyl, alkenyl or alkynyl groups may be interrupted with N, O or S, and
wherein R⁶—O is a carboxylate anion, a sulfur trioxide anion, an acetamide anion, which may be interrupted by a methyl group, a straight or branched C₂-C₂₀ alkenyl group, a straight or branched C₂-C₂₀ alkynyl group, wherein each of the C₂-C₂₀ alkyl, alkenyl or alkynyl groups may be interrupted with N, O or S.

11. The method of claim 1, wherein the reagent composition comprises at least one lithium selective extractant having the following formulas:

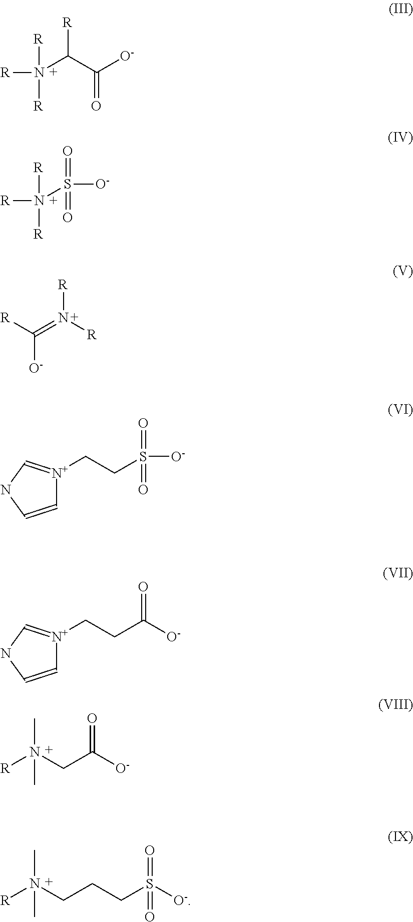

12. The method of claim 1, wherein the reagent composition comprises at least one lithium selective extractant having formula (XI): 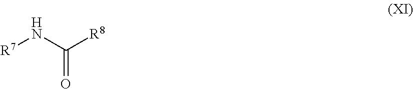
wherein R⁷ and R⁸ is each independently a methyl group, a straight or branched C₂-C₂₀ alkenyl group, a straight or branched C₂-C₂₀ alkynyl group, wherein each of the C₂-C₂₀ alkyl, alkenyl or alkynyl groups may be interrupted with N, O, S or carbonyl.

13. The method of claim 1, further comprising at least one modifier, wherein the modifier comprises at least one of:
one or more functional group having a dipole moment and/or that is attached to a highly polar ionic bond,
an aliphatic component that is attracted to non-polar moieties of the at least one lithium selective extractant,
one or more functional group chosen from a diether, amide, imide, ketone, alcohol, ether, alkyl phosphine, phosphate, ester, and/or nitrile, or 1,6-di-t-butoxy hexane, N,N-Dimethyldecanamide, Di (ethylene glycol) dibutyl ether, N,N-Dimethyldecanamide, N,N-Diethyldodecanamide, N,N-Diethyl-2-ethyl hexanamide, 1,4-bis-t-Butoxy butane, 2-Ethylhexyl succinimide, 4-t-butylcyclohexanone, iminodiacetic acid (IDA), Dodecanol, 2,2,4-Trimethyl-1,3-pentanediol diisobutyrate (TXIB), Ethyoxylated isotridecyl phosphate (TDA), Cydecanol, 7-Ethyl-2-methyl-undecanol, Trimethyl nonanol, 4-Isopropyl cyclohexanone, t-Butyl octyl ether, 3-Isopropyl cyclohexanone, 3,3,5-Trimethyl cyclohexanone, Methyl n-propyl ketone (Eastman C-11 Ketone), 5-Ethyl-2-nonanone, a mixture of phosphine oxides (Cyanex 923), Tributyl phosphate, 6-Undecanone, Heptyl 2-ethylbutyrate, 2-Ethylbutyl caproate, 3-(Cyclohexyl)-propionitrile, or combinations thereof.

14. (canceled)

15. (canceled)

16. (canceled)

17. The method of claim 1, further comprising emulsifying the lithium enriched organic phase.

18. The method of claim 1, further comprising separating the lithium salt depleted aqueous phase from the lithium enriched organic phase.

19. The method of claim 1, further comprising stripping the lithium from the lithium enriched organic phase,
optionally, wherein about 70% to about 99%, or about 95% of the lithium is stripped from the lithium enriched organic phase.

20. The method of claim 1, wherein the overall extraction of lithium from the aqueous mixed salt solution is greater than about 70% or about 70% to about 99%.

21. The method of claim 1, wherein the selectivity of lithium over magnesium is about 1 to about 50.

22. A treated salar brine composition comprising:
a treated salar mineral comprising lithium, magnesium, calcium, potassium, sodium, or combinations thereof; and
water having a concentration of lithium of less than about 25,000 mg/kg, a concentration of magnesium of less than about 130,000 mg/kg, and a concentration of calcium of less than about 50,000 mg/kg.

23. The treated salar brine composition of claim 22, wherein the concentration of lithium is less than about 10,000 mg/kg, less than about 5,000 mg/kg, less than about 1,500 mg/kg, or any individual value or sub-range within these ranges, or
wherein the concentration of lithium is less than about 4,000 mg/kg, the concentration of magnesium is less than about 55,000 mg/kg, and the concentration of calcium is less than about 9,000 mg/kg, or
wherein the concentration of lithium is less than about 400 mg/kg, the concentration of magnesium is less than about 60,000 mg/kg, and the concentration of calcium is less than about 8,000 mg/kg, or
wherein the concentration of lithium is less than about 3,500 mg/kg, the concentration of magnesium is less than about 50,000 mg/kg, and the concentration of calcium is less than about 12,000 mg/kg.

24. (canceled)

25. (canceled)

26. (canceled)

27. The treated salar brine composition of claim 22, wherein the minerals comprise salar waste mineral, a salar carnallite, lithium carnallite, bischofites, carnallite, kieserite, or combinations thereof.

28. A method of using a treated salar brine composition, comprising:
extracting one or more minerals from the composition of claim 22
injecting the composition of claim 22 into a tailings pond, or
injecting the composition of claim 22 into a salar brine reservoir or a salt flat reservoir.

29. (canceled)

30. (canceled)

31. A composition comprising:
a lithium containing treated salar brine; and
an organic composition capable of reducing the concentration of lithium in the lithium containing treated salar brine.

32. The composition of claim 31, wherein the lithium containing treated salar brine comprises a lithium concentration of less than about 20,000 mg/kg, less than about 5,000 mg/kg, or any individual value or sub-range within these ranges.
